(19) United States
(12) Patent Application Publication
(10) Pub. No.: US 2009/0314903 A1
(43) Pub. Date: Dec. 24, 2009

(54) PIPE CLAMPS

(76) Inventors: Terry L. Zahuranec, North Olmsted, OH (US); Matthew L. Schmidt, Avon, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/204,968

(22) Filed: Sep. 5, 2008

Related U.S. Application Data
(60) Provisional application No. 61/074,160, filed on Jun. 20, 2008.

(51) Int. Cl. F16L 3/08

(52) U.S. Cl. 248/74.1

(57) ABSTRACT

Pipe clamps may include at least two laterally spaced pipe retaining recesses extending through the body member of the pipe clamps between opposite sides. At one end of the body member is a mounting flange for attaching the pipe clamps to a support structure. Additional pipe clamps having at least one pipe retaining recess may be selectively attached to the other end of the pipe clamps to expand the pipe clamps for selectively securing additional pipes off a support structure.

### CROSS-REFERENCE TO RELATED APPLICATIONS

This application claims the benefit of U.S. Provisional Application No. 61/074,160, filed Jun. 20, 2008.

### FIELD OF THE INVENTION

This invention relates generally to pipe clamps or hangers for fast and easy installation of two or more pipes to both vertical and horizontal support structures.

### BACKGROUND OF THE INVENTION

Pipe clamps or hangers are commonly used in the plumbing industry to attach pipes including particularly hot and cold water lines to both vertical and horizontal support structures. An objection to previous pipe clamps is that it is not very convenient or easy to gang the pipe clamps to route additional pipes off the same support structure.

Another objection to previous pipe clamps is that oftentimes they mount the pipes too close to vertical or horizontal supports, increasing the risk of a drywall installer nailing or screwing into the pipes during installation of the drywall to the vertical or horizontal supports. This is particularly a problem when the pipes are made of plastic, including PEX and CPVC.

### SUMMARY OF THE INVENTION

The present invention relates to various improvements in pipe clamps that overcome the various objections outlined above.

In accordance with one aspect of the invention, the pipe clamps may include two or more laterally spaced pipe retaining recesses for selectively mounting two or more pipes off a support structure or framing surface.

In accordance with another aspect of the invention, the pipe clamps may have a mounting flange at one end, and mounting tabs protruding from opposite sides of the mounting flange outwardly beyond opposite sides of the clamp body, with fastener holes extending through the tabs outwardly of the clamp body for attaching the clamps to a vertical or horizontal support structure.

In accordance with another aspect of the invention, fastener holes may extend through the pipe clamps between the top and bottom surfaces adjacent the ends of the pipe clamps for receiving fasteners for attaching the pipe clamps to a support structure.

In accordance with another aspect of the invention, one end of the pipe clamps may have an interlocking connection engageable with a complementary interlocking connection on an end of another pipe clamp for expanding the pipe clamp for mounting one or more additional pipes off a support structure.

In accordance with another aspect of the invention, both ends of the other pipe clamp may have complementary interlocking connections to permit more than one other pipe clamp to be connected to the pipe clamp and to each other to expand the pipe clamp for selectively mounting additional pipes off a support structure.

In accordance with another aspect of the invention, the ends of multiple pipe clamps may have complementary interlocking connections to permit additional pipe clamps to be connected together in end to end relation to expand the number of pipes that can be selectively secured off a support structure.

In accordance with another aspect of the invention, each pipe retaining recess may have a semi-cylindrical inner end of a radius substantially corresponding to the radius of the pipe to be retained thereby, a convexly rounded corner adjacent one end of the recess for guiding the pipe into the recess, and a flexible retention member extending at an angle toward the inner end of the recess, the retention member having an inner end spaced from the rounded corner a distance less than the diameter of the pipe requiring the retention member to be flexed away from the rounded corner to insert the pipe into the semi-cylindrical inner end of the recess.

In accordance with another aspect of the invention, the inner end of the retention member may be radially outwardly spaced from a center axis of the semi-cylindrical inner end of the recess a distance substantially corresponding to the radius of the semi-cylindrical inner end, whereby when the pipe is fully inserted into the recess, the inner end of the retention member retains the pipe in the recess.

In accordance with another aspect of the invention, at least the pipe retaining recess closest to the mounting flange may extend at an angle away from the mounting flange to increase the spacing between a vertical or horizontal support structure when the mounting flange is attached thereto and the semi-cylindrical inner end of the pipe retaining recess to minimize the risk of a drywall installer hitting the pipe with a fastener during installation of drywall to the vertical or horizontal support structure.

To the accomplishment of the foregoing and related ends, the invention, then, comprises the features hereinafter more fully described and particularly pointed out in the claims, the following description and the annexed drawings setting forth in detail certain illustrative embodiments of the invention, these being indicative, however, of but several of the various ways in which the principles of the invention may be employed.

### BRIEF DESCRIPTION OF THE DRAWINGS

In the annexed drawings:

FIG. 1 is a perspective view of one form of pipe clamp of the present invention shown attached to a vertical support structure.

FIG. 2 is a perspective view of the pipe clamp of FIG. 1 shown attached to a horizontal support structure.

FIG. 3 is a side view of one side of the pipe clamp of FIGS. 1 and 2.

FIG. 4 is a top plan view of the pipe clamp of FIG. 3.

FIG. 5 is a bottom plan view of the pipe clamp of FIG. 3.

FIG. 6 is a left end view of the pipe clamp of FIG. 3.

FIG. 7 is a right end view of the pipe clamp of FIG. 3.

FIG. 8 is a perspective view of the pipe clamp of FIG. 1 and another pipe clamp that are connectable together in end to end relation for expanding the pipe clamp for selectively securing one or more additional pipes off a support structure.

FIG. 9 is a perspective view showing the two pipe clamps of FIG. 8 connected together and attached to a support structure for selectively mounting at least three pipe clamps off a support structure.

FIG. 10 is a side elevation view of one side of the other pipe clamp shown in FIG. 8.

FIG. 11 is a top plan view of the pipe clamp of FIG. 10.

FIG. 12 is a bottom plan view of the pipe clamp of FIG. 10.

FIG. 13 is a left end view of the pipe clamp of FIG. 10.

FIG. 14 is a right end view of the pipe clamp of FIG. 10.

### DETAILED DESCRIPTION OF THE INVENTION

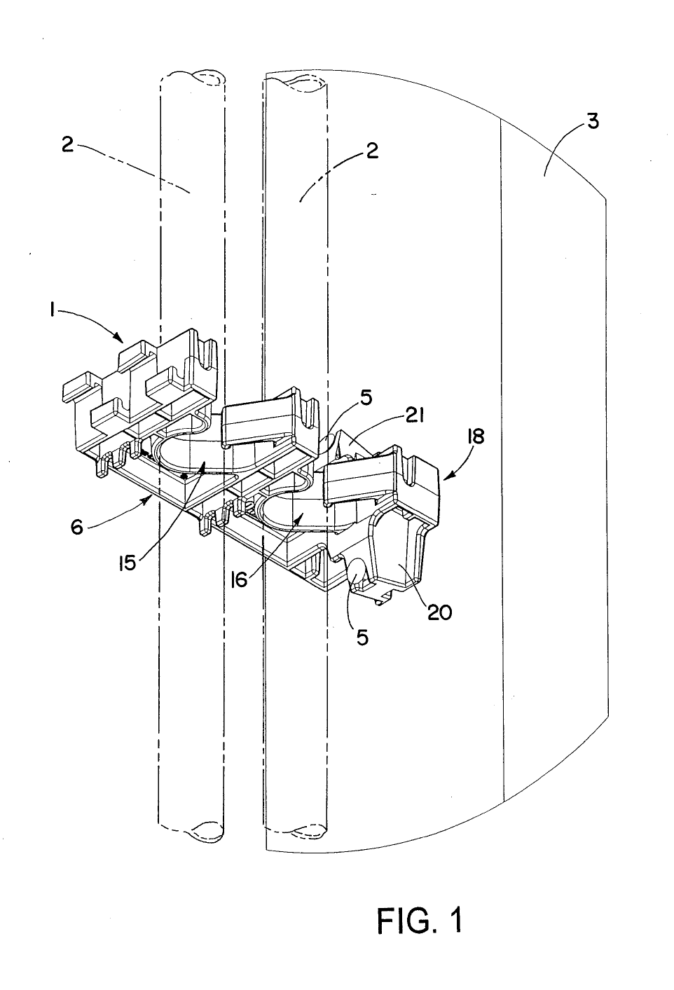

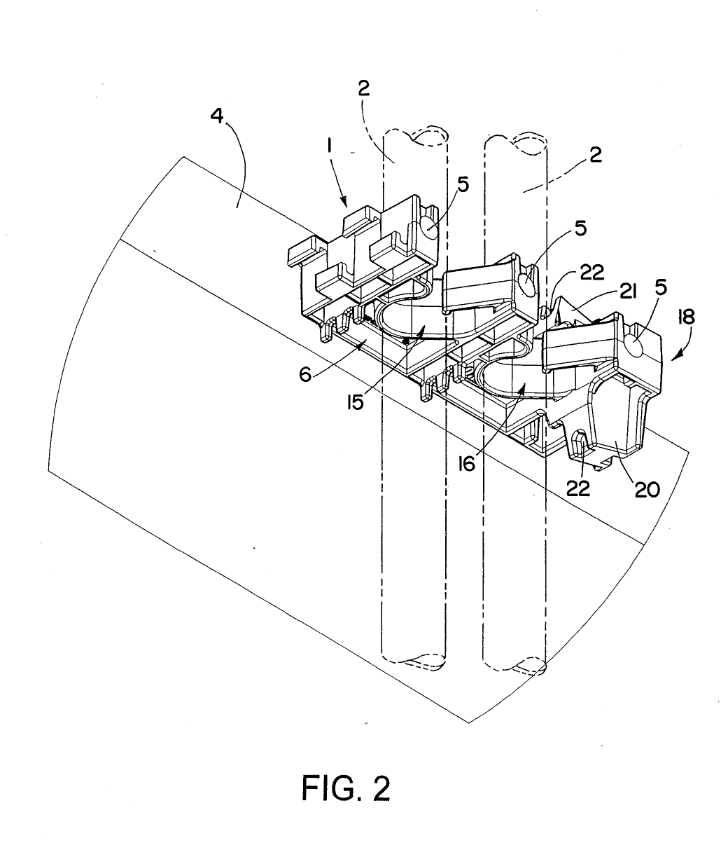

Referring now in detail to the drawings, and initially to FIGS. 1 and 2, there is shown one form of multi-run pipe clamp 1 in accordance with this invention for mounting all types of piping 2, including for example PEX, CPVC, and copper tube size piping, off a suitable support structure or framing surface such as a vertical stud or horizontal floor or ceiling joist. FIG. 1 shows pipe clamp 1 attached to one side of a vertical stud 3 of a stud bay, whereas FIG. 2 shows the same pipe clamp attached to a horizontal floor or ceiling joist 4. If the support structure or framing surface is made for example of wood, composite or plastic, the fasteners 5 used to attach the pipe clamp to the support structure would typically be nails, whereas if the support structure is made of metal, the fasteners would typically be metal screws. However, any suitable fastener may be used for this purpose.

Pipe clamp 1 shown in FIGS. 1 and 2 is a two run pipe clamp, which is ideal for supporting one hot and one cold water supply line. However, if desired, the pipe clamp may include more than two pipe runs, for example, three pipe runs or four pipe runs, depending on need. Also, the pipe clamp may be of a modular design allowing one or more additional modular pipe clamps having one or more pipe runs to be connected to the pipe clamp to expand the pipe clamp for selectively supporting additional lines if desired.

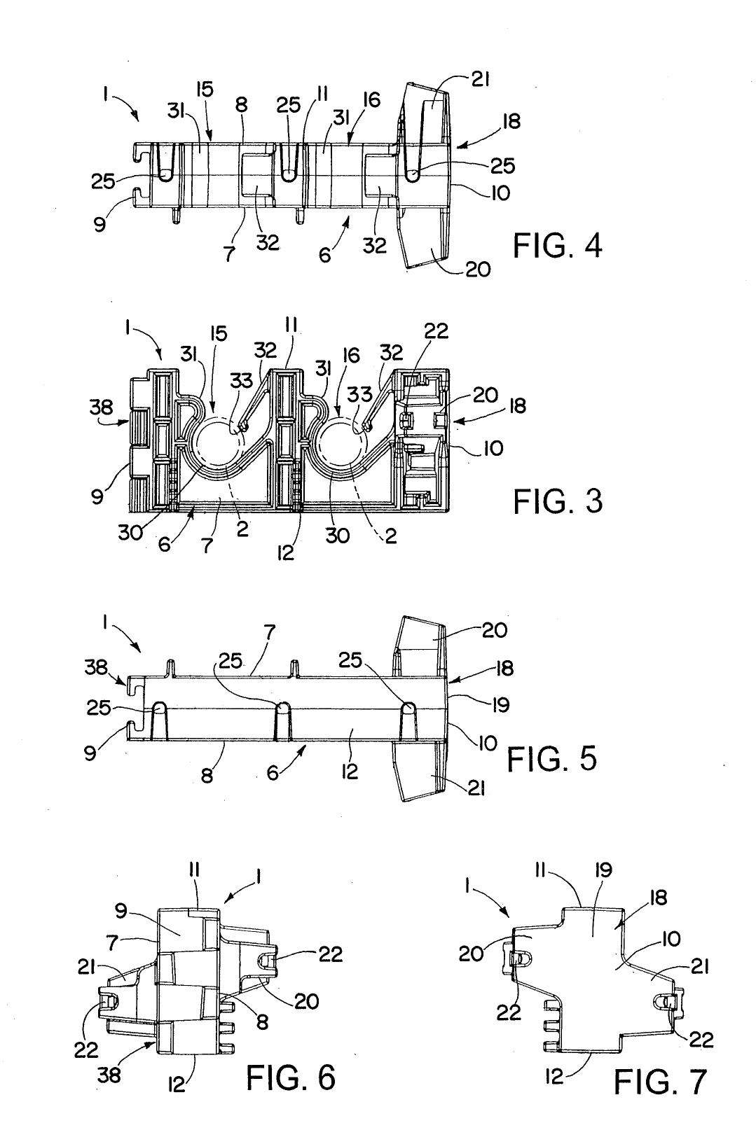

The pipe clamp may be made out of a suitable plastic material such as high impact ABS, and as best seen in FIGS. 3-7, includes a main body member 6 having opposite sides 7, 8 and ends 9, 10 and top and bottom surfaces 11, 12. Extending through body member 6 of pipe clamp 1 between opposite sides 7, 8 are a pair of pipe retaining recesses 15, 16 laterally spaced from each other and from the ends and top and bottom surfaces. These recesses are accessible from the top surface 11 for selectively securing a pipe 2 in each recess to eliminate contact between the pipes and framing surfaces and insulate against sound and vibration.

To facilitate attachment of the pipe clamp 1 to a vertical or horizontal support structure 3, a mounting flange 18 is provided at one end of body member 6. Mounting flange 18 may have a substantially flat outer end wall 19 for engagement with the support structure. Fastener tabs 20, 21 protrude outwardly from opposite sides of the mounting flange outwardly beyond opposite sides of the body member, the fastener tabs having fastener holes 22 extending therethrough outwardly of the body member for receiving suitable fasteners for connecting the clamp to a support structure. Preferably the fastener tabs 20, 21 are laterally offset from each other as best seen in FIGS. 6 and 7 to allow the pipe clamp to be molded in an open and shut tool without lifters. Also the fastener holes 22 are desirably (but need not be) angled inwardly from top to bottom as further shown in FIGS. 6 and 7 so the fasteners are towed in when driven through the fastener holes into a suitable support to provide a more secure mount.

Additional fastener holes 25 extend through the body member 6 between the top and bottom surfaces 11, 12 adjacent the ends 9, 10 for receiving suitable fasteners 5 for attaching the pipe clamp to a support structure 14 as shown in FIG. 2. An additional fastener hole 25 may also extend through the body member between the top and bottom surfaces intermediate the pipe retaining recesses 15, 16 for selectively receiving another fastener for more securely attaching the pipe clamp to a support structure.

The fastener holes may be slightly undersized to permit fasteners to be preloaded in the fastener holes without having to hold the fasteners in the holes. Also the fastener holes may be slotted along their length to reduce friction on the fasteners when driven through the fastener holes. These same fastener holes may be used to attach the pipe clamp to a support structure or framing surface for supporting horizontal pipe runs as well as vertical pipe runs if desired.

As best seen in FIGS. 3 and 4, each pipe retaining recess 15, 16 has a semi-cylindrical inner end 30 of a radius substantially corresponding to the radius of the pipe to be retained thereby, for example, a ¼ inch radius for securing ½ inch pipe, a ⅜ inch radius recess for ¾ inch pipe, etc. Adjacent one end of each recess is a convexly rounded corner 31 for guiding the pipe into the recess. Laterally spaced from the rounded corner 31 is a flexible retention member 32 that extends at an angle toward the inner end of each recess and has a free inner end 33 spaced from the rounded corner a distance less than the diameter of the pipe requiring the retention member to be flexed away from the rounded corner to insert the pipe into the recess. Also, the inner end of the retention member is desirably radially outwardly spaced from the center axis of the semi-cylindrical inner end of the recess a distance substantially corresponding to the radius of the semi-cylindrical inner end, whereby when the pipe 2 is fully inserted into the semi-cylindrical inner end of the recess as shown in phantom lines in FIG. 3, the inner end of each retention member securely retains the pipe in the recess to insulate the pipe against sound and vibration. Further, the inner end of the retention member is desirably rounded and overlies the pipe when fully inserted into each recess as further shown in FIG. 3 to prevent inadvertent removal of the pipe therefrom.

Preferably the pipe retaining recess 16 closest to the mounting flange 18 at one end of the pipe clamp extends at an angle away from the mounting flange (see FIG. 3) to increase the spacing between a vertical or horizontal support structure when the mounting flange is attached thereto and the pipe retaining recess to minimize the risk of a drywall installer nailing or screwing into the pipe during installation of drywall to a vertical or horizontal support structure. This is particularly important when the pipe is made out of plastic such as PEX or CPVC. The other pipe retaining recess 15 may be similarly angled.

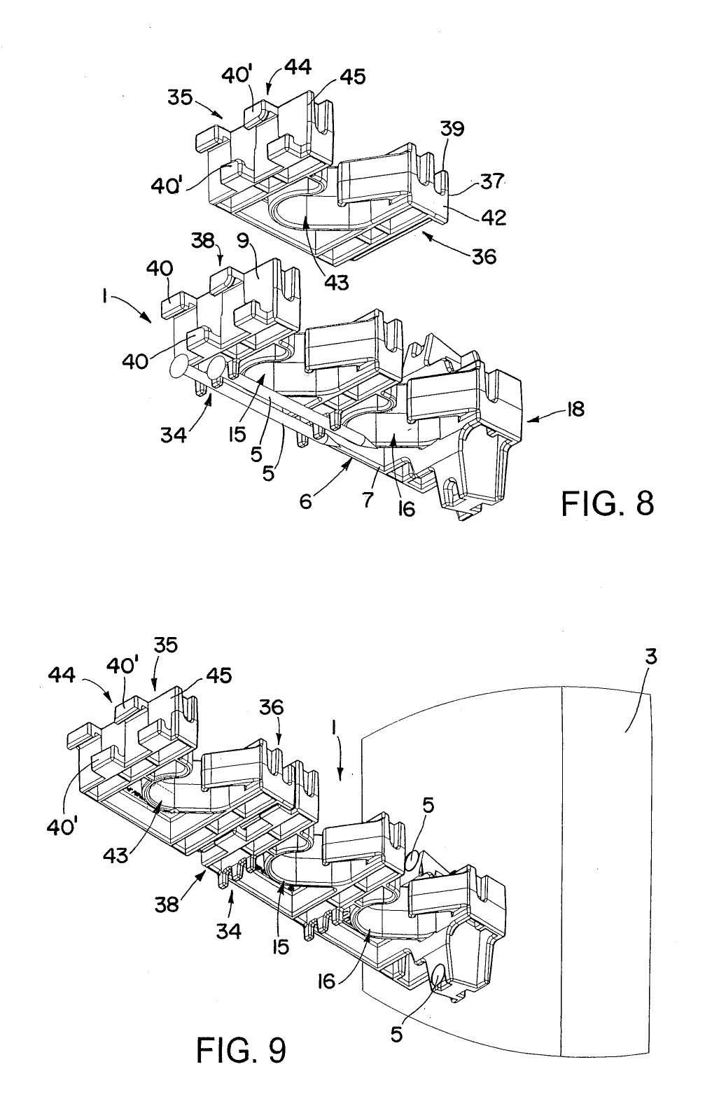

Pipe clamp 1 may be provided with one or more fastener retention members 34 on one side 7 of the body member 6 for preloading fasteners 2 along the one side as schematically shown in FIG. 8 for use as needed to secure the pipe clamp to a suitable support structure.

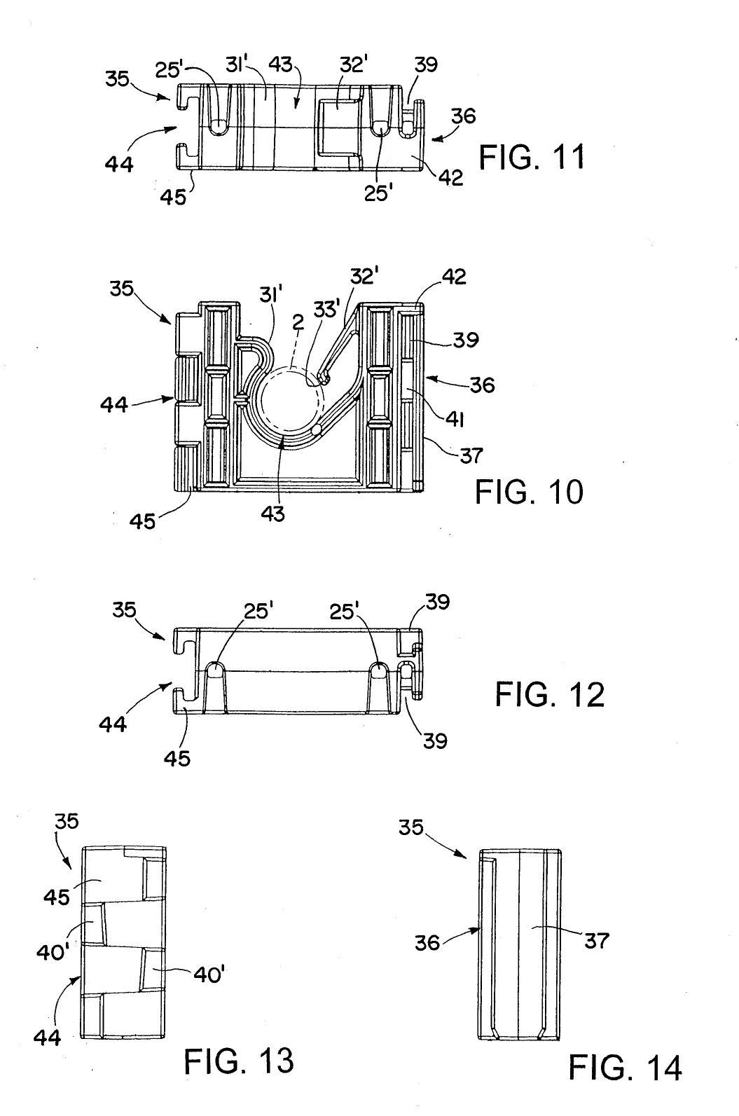

Also, pipe clamp 1 may be of a modular design that allows one or more additional modular pipe clamps to be easily connected to pipe clamp 1 to expand the pipe clamp for selectively supporting additional pipe lines off the same pipe clamp. FIG. 8 shows one such additional pipe clamp 35 having an interlocking connection 36 at one end 37 in position for sliding engagement with a complementary interlocking connection 38 at the end 9 of the pipe clamp 1 opposite the mounting flange 18 as shown in FIG. 9 to expand the pipe clamp for supporting one or more additional pipe lines. In the exemplary embodiment disclosed herein, one of the interlocking connections 36 may include a pair of laterally spaced grooves 39 on opposite sides of the body member at the one end 37 for sliding engagement by laterally spaced tabs 40 of the other interlocking connection 38. Also the grooves 39 may have slots 41 along their length (see FIG. 10), and some of the tabs 40 may be tapered or beveled outwardly along their length as best seen in FIGS. 6 and 8 for snapping engagement into the respective slots 41 during sliding of the two clamps together. A stop shoulder 42 may be provided at one end of one of the grooves 39 of interlocking connection 36 to limit the extent of sliding engagement of the two interlocking connections 36, 38 together.

The additional modular pipe clamp 35 shown in FIGS. 8-14 only has one pipe retaining recess 43, which may be of substantially the same construction as the two pipe retaining recesses 15, 16 in pipe clamp 1 previously described. Accordingly, the same reference numerals followed by a prime symbol are used to designate like parts. However, it will be appreciated that the additional modular pipe clamp 35 may include more than one pipe retaining recess if desired. Also, the additional modular pipe clamp 35 may have a complementary interlocking connection 44 at its other end 45 substantially corresponding to the interlocking connection 38 on pipe clamp 1 as further shown in FIGS. 8-14 to allow more than one additional pipe clamp to be connected to pipe clamp 1 and to each other substantially in the same manner as previously described. Accordingly, the same reference numerals followed by a prime symbol (′) are used to designate like parts.

Although the invention has been shown and described with respect to certain preferred embodiments, it is obvious that equivalent alterations and modifications will occur to others skilled in the art upon the reading and understanding of the specification. The present invention includes all such equivalent alterations and modifications, and is limited only by the scope of the claims.

1.-19. (canceled)

20. A pipe clamp for mounting at least one pipe off a support structure or framing surface, the pipe clamp comprising a body member having opposite sides and ends and top and bottom surfaces, and at least one pipe retaining recess extending through the body member between the opposite sides in laterally spaced relation from the ends and top and bottom surfaces, the recess being accessible from the top surface for selectively securing a pipe in the recess, a mounting flange at one end of the body member, the mounting flange having an outer end wall facing away from the one end of the body member for engagement with a support structure, fastener tabs protruding outwardly from opposite ends of the mounting flange transversely outwardly beyond the opposite sides of the body member, and fastener holes extending through the fastener tabs transversely outwardly of the opposite sides of the body member for attaching the outer end wall of the mounting flange to a support structure.

21. The pipe clamp of claim 20 wherein the fastener tabs are laterally offset from each other with one of the fastener tabs closer to the top surface or the bottom surface of the body member than the other fastener tab.

22. The pipe clamp of claim 20 wherein the fastener holes are angled inwardly in the direction of the outer end wall of the mounting flange.

23. The pipe clamp of claim 20 wherein one of the sides of the body member has one or more fastener retention means for preloading fasteners along the one side.

24. The pipe clamp of claim 20 wherein the bottom side of the body member is substantially flat, and fastener hole means extend through the body member between the top and bottom surfaces for receiving fastener means for attaching the clamp to a support structure.

25. The pipe clamp of claim 20 wherein the other end of the pipe clamp and one or more additional pipe clamps have complementary interlocking ends to permit additional pipe clamps to be connected td the pipe clamp in end to end relation to expand the number of pipes that can be selectively secured off a support structure, and wherein the complementary interlocking ends are shaped to provide snap connections therebetween during sliding of the interlocking ends of the pipe clamps together.

26. The pipe clamp of claim 25 wherein one of the complementary interlocking ends includes a pair of laterally spaced grooves on the opposite sides of the body member of one associated pipe clamp, and the other complementary interlocking end of another associated pipe clamp includes laterally spaced tabs for sliding engagement in the laterally spaced grooves.

27. The pipe clamp of claim 26 wherein there are slots along the length of the grooves, and at least some of the tabs are tapered or beveled outwardly along the length of the tabs for snapping engagement of the tapered or beveled tabs into the slots during sliding of the interlocking ends of the pipe clamps together.

28. The pipe clamp of claim 26 wherein there is a stop shoulder at one end of one of the grooves to limit the extent of sliding engagement of the complementary interlocking ends of the pipe clamps together.

29. The pipe clamp of claim 20 wherein the at least one pipe retaining recess has a semi-cylindrical inner end of a radius substantially corresponding to the radius of a pipe for mounting in the recess, a convexly rounded corner adjacent one end of the recess, and a flexible retention member extending at an angle toward the inner end of the recess, the retention member having an inner end spaced from the rounded corner a distance less than the diameter of a pipe for mounting in the recess.

30. The pipe clamp of claim 29 wherein the inner end of the retention member is radially outwardly spaced from a center axis of the semi-cylindrical inner end of the recess a distance substantially corresponding to the radius of the semi-cylindrical inner end.

31. The pipe clamp of claim 20 wherein the at least one pipe retaining recess is in close proximity to the mounting flange and extends at an angle away from the mounting flange to increase the spacing between the mounting flange and a semi-cylindrical inner end of the pipe retaining recess to minimize risk of a drywall installer damaging a pipe when mounted in the recess by a drywall fastener during installation of drywall to the support structure.

32. The pipe clamp of claim 31 wherein the at least one pipe retaining recess has a convexly rounded corner adjacent an end of the recess furthest from the mounting flange, and a flexible retention member extending at an angle toward the inner end of the recess, the retention member having an inner end spaced from the rounded corner a distance less than the diameter of a pipe for mounting in the recess.

33. The pipe clamp of claim 20 wherein the body member is an integral one piece construction, and there are at least two pipe retaining recesses extending through the body member between the opposite sides in laterally spaced relation from each other and from the ends and the top and bottom surfaces, the recesses being accessible from the top surface.

34. The pipe clamp of claim 33 wherein one of the pipe retaining recesses is in close proximity to the mounting flange and extends at an angle away from the mounting flange to increase the spacing between the mounting flange and a semi-cylindrical inner end of the one pipe retaining recess to minimize risk of a drywall installer damaging a pipe when mounted in the one pipe retaining recess by a drywall fastener during installation of drywall to the support structure.

35. The pipe clamp of claim 34 wherein another of the pipe retaining recesses in close proximity to the one pipe retaining recess also extends at an angle away from the mounting flange.

36. A pipe clamp for mounting one or more pipes off a support structure or framing surface, the pipe clamp comprising a body member having opposite sides and ends and top and bottom surfaces, and at least one pipe retaining recess in the body member, wherein at least one end of the body member has an interlocking connection for interlocking engagement with a complementary interlocking connection on an end of another pipe clamp, and wherein complementary interlocking ends of the pipe clamps are shaped to provide snap connections therebetween during sliding of the interlocking ends of the pipe clamps together.

37. The pipe clamp of claim 36 wherein one of the complementary interlocking ends includes a pair of laterally spaced grooves on the opposite sides of the body member of one associated pipe clamp, and the other complementary interlocking end of another associated pipe clamp includes laterally spaced tabs for sliding engagement in the laterally spaced grooves.

38. The pipe clamp of claim 37 wherein there are slots along the length of the grooves, and at least some of the tabs are tapered or beveled outwardly along the length of the tabs for snapping engagement of the tapered or beveled tabs into the slots during sliding of the interlocking ends of the pipe clamps together.

39. The pipe clamp of claim 37 wherein there is a stop shoulder at one end of one of the grooves to limit the extent of sliding engagement of the complementary interlocking ends of the pipe clamps together.
